(19) United States
(12) Patent Application Publication
(10) Pub. No.: US 2013/0206850 A1
(43) Pub. Date: Aug. 15, 2013

(54) TEMPERATURE-BASED FLOW REGULATOR

(71) Applicant: Bruce Erickson, Monticello, MN (US)

(72) Inventor: Bruce Erickson, Monticello, MN (US)

(21) Appl. No.: 13/621,309

(22) Filed: Sep. 17, 2012

Related U.S. Application Data
(60) Provisional application No. 61/633,550, filed on Feb. 13, 2012.

(51) Int. Cl. F23N 3/04; A47J 37/07; G05D 23/02

(52) U.S. Cl. 236/1 G; 236/101 D; 126/289

(57) ABSTRACT

A flow regulator for a solid fuel grill may include a housing having an opening and configured for coupling to a solid fuel grill over a vent opening of the grill and the regulator may also include a damper assembly arranged on the housing where the damper assembly may include a damper arranged to operably and variably open and close the opening and the damper assembly may also include a temperature sensitive damper controller operably connected to the housing and the damper to open and close the damper based on temperature changes.

### CROSS REFERENCE TO RELATED APPLICATIONS

The present application claims priority to U.S. Provisional Patent Application No. 61/633,550 filed on Feb. 12, 2012 entitled TipTopTemp, the contents of which are hereby incorporated by reference herein in their entirety.

### FIELD OF THE INVENTION

The present disclosure relates generally to devices and methods for controlling the flow of fluids including air or other gases as well as water, coolants, or other liquids. More particularly, the present disclosure relates to devices and methods for controlling the flow of exhaust gases from a combustion chamber so as to, in turn, control the temperature in the combustion chamber. Still more particularly, the present disclosure relates to devices and methods for controlling the flow of exhaust gases from a solid fuel cooking apparatus such as a grill that uses charcoal, wood, pellets, paper, or other solid combustible fuel.

### BACKGROUND

Common grills for cooking food generally include gas fueled grills and grills that are fueled with solid fuel such as charcoal, wood, pellets, and the like. Temperature control using a gas grill generally involves adjusting the flow of gas to the combustion chamber by adjusting a dial. Due to this relatively fine adjustment capability, the ability to regulate the temperature and maintain a constant temperature is relatively simple. Like gas grills, temperature control using a solid fuel grill may also involve adjusting the amount of fuel in the combustion chamber. However, the very nature of solid fuel is such that the temperature provided tends to start out low, rise as the fuel gets burning, and then taper off as the fuel begins to run out. Accordingly, in an effort to control the temperature more precisely and maintain a more constant temperature when cooking, users may also manually open and close vent openings to regulate the air flow through the combustion chamber and thereby control the temperature of the grill. This manual adjustment of vent openings requires constant attention to the grill and exposes the user to bums. This approach often leads to wide temperature variations when the vents are inconsistently opened and closed.

### SUMMARY

In one embodiment, a flow regulator for controlling the temperature of a solid fuel grill may be provided. The regulator may include a housing having an opening and the housing may be configured for coupling to the solid fuel grill over a vent opening of the grill. The regulator may also include a damper assembly arranged on the housing. The damper assembly may include a damper arranged to operably and variably open and close the opening in the housing. The damper assembly may also include a temperature sensitive damper controller operably connected to the housing and the damper to open and close the damper based on temperature changes.

In another embodiment, a flow regulated solid fuel grill may be provided. The grill may include a combustion chamber for burning solid fuels and having an inlet vent and an exhaust vent. The grill may also include a flow regulator for controlling the temperature of the grill. The regulator may be arranged in fluid communication with one of the inlet vent and the exhaust vent and the regulator may include a damper assembly. The damper assembly may include a damper arranged to operably and variably open and close. The damper assembly may also include a temperature sensitive damper controller operably connected to the damper to open and close the damper based on temperature changes in gases passing through the respective vent.

In yet another embodiment, a flow regulator for controlling the temperature of a solid fuel grill may include a means for sensing the temperature of the grill and reacting to the temperature to control flow of air through the grill. The flow regulator may also include a means for securing the means for sensing and reacting to the grill over a vent of the grill.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed description is to be regarded as illustrative in nature and not restrictive.

### BRIEF DESCRIPTION

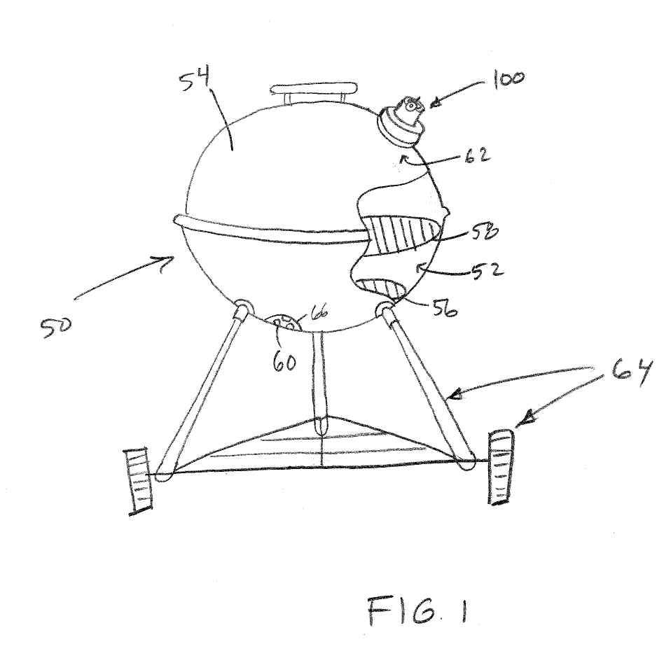

FIG. 1 shows a perspective view of a temperature-based flow regulator in place on a solid fuel grill, according to some embodiments.

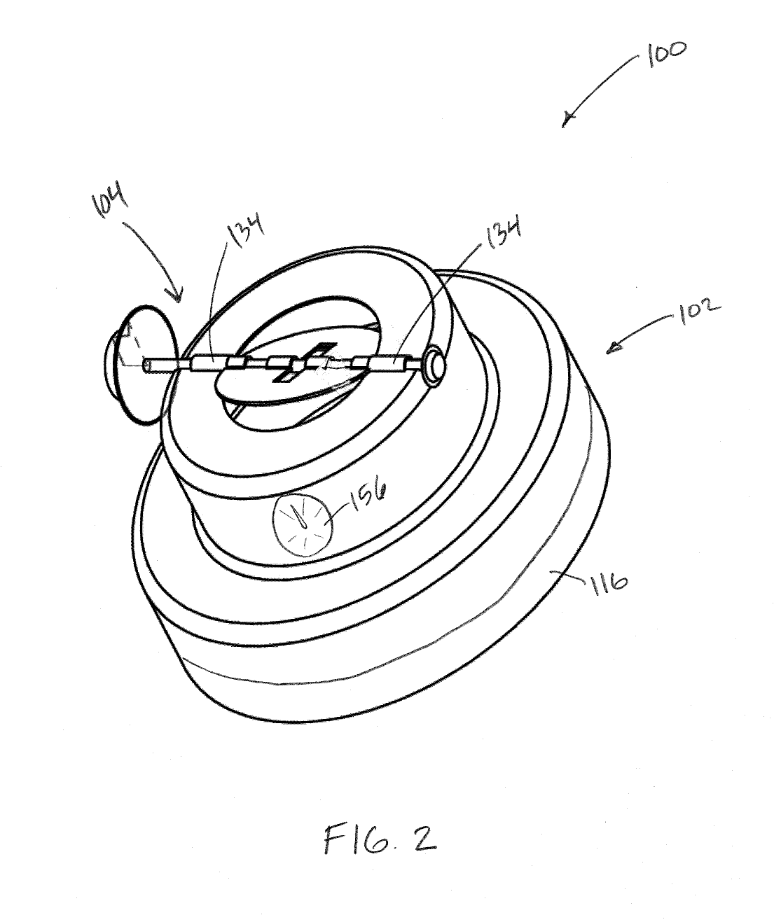

FIG. 2 shows a perspective view of the regulator of FIG. 1.

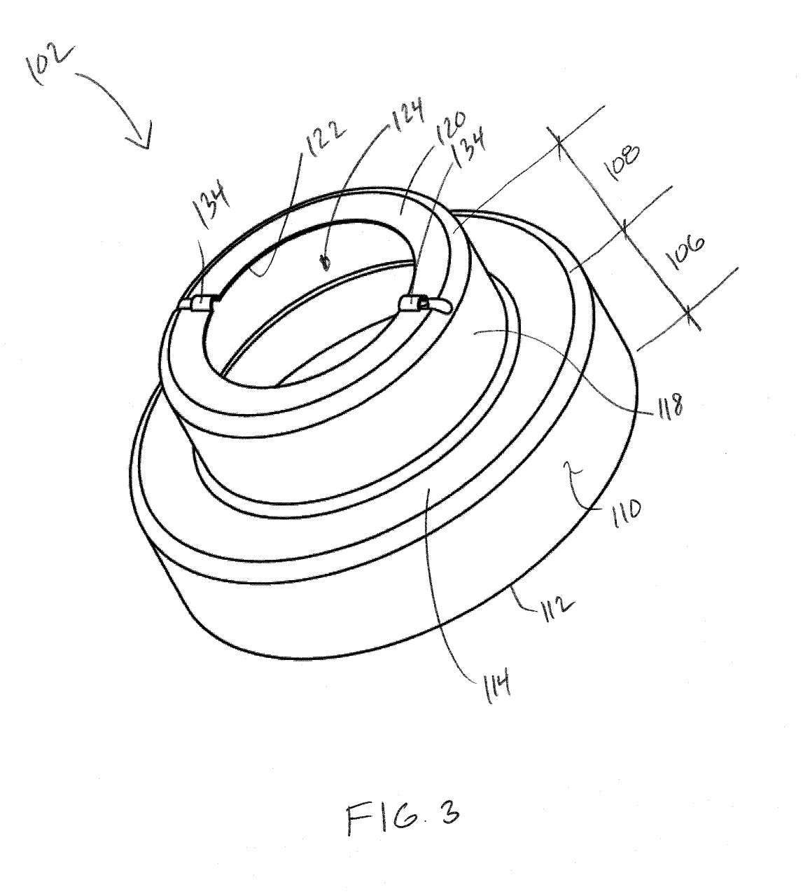

FIG. 3 shows a perspective view of a housing of the regulator of FIG. 1.

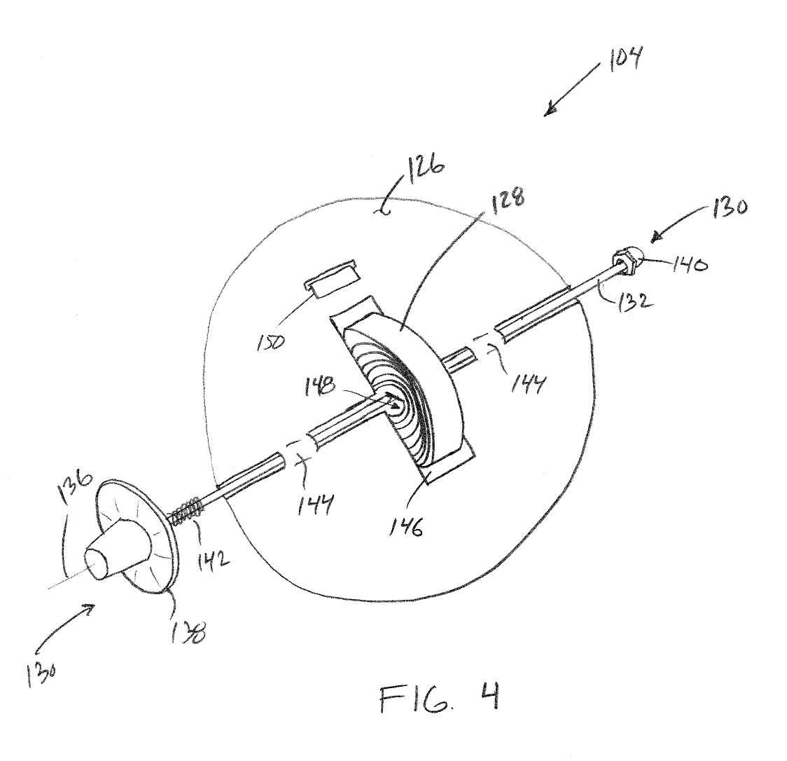

FIG. 4 shows a perspective view of a damper assembly of the regulator of FIG. 1.

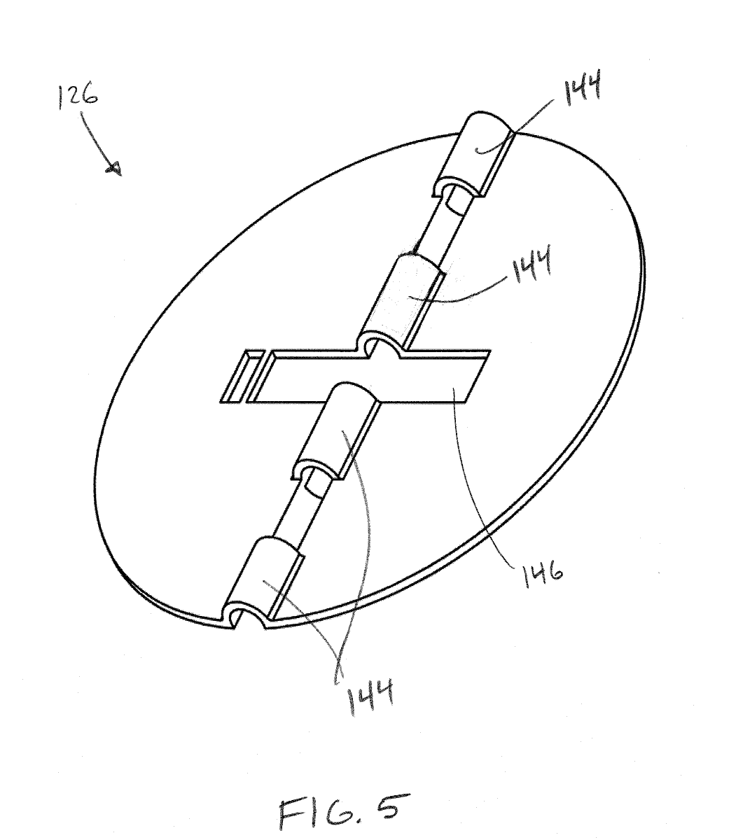

FIG. 5 shows a perspective view of a damper of the assembly of FIG. 4.

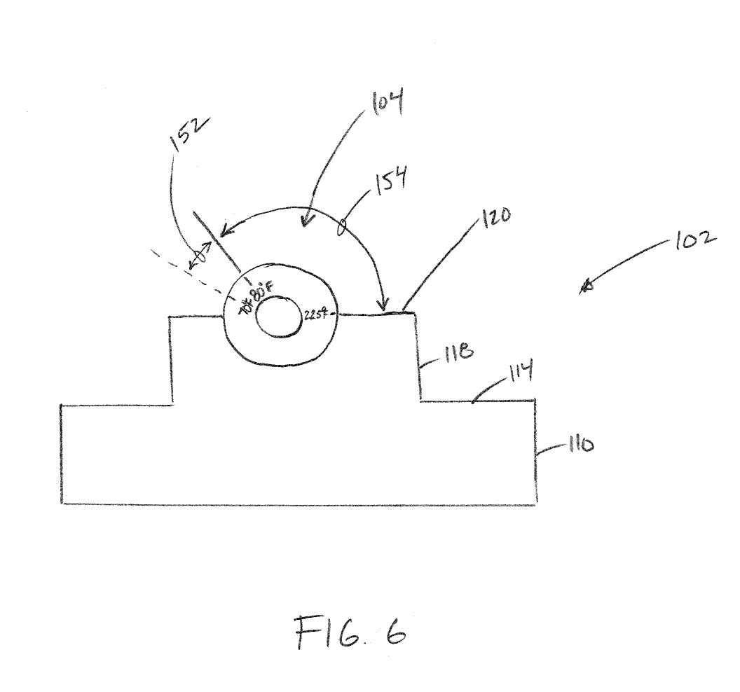

FIG. 6 shows a temperature setting diagram, according to some embodiments.

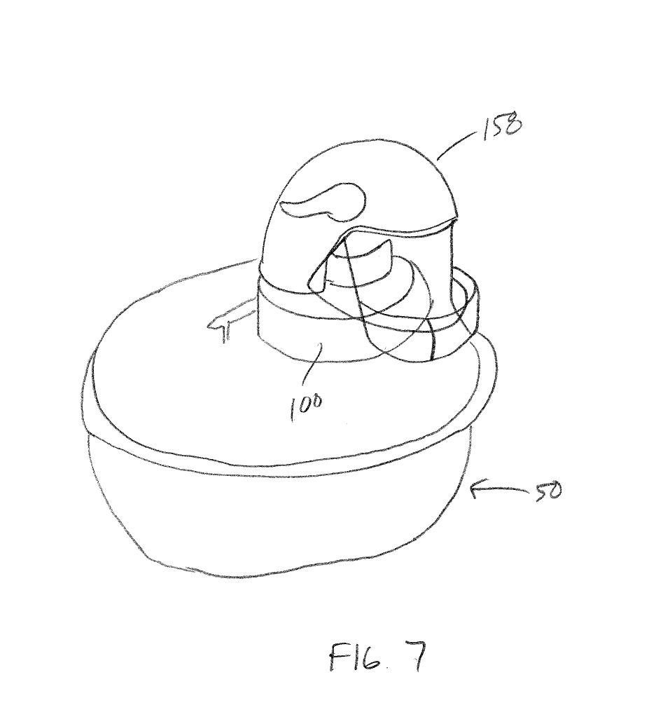

FIG. 7 shows a perspective view of the grill and regulator of FIG. 1 including a novelty feature, according to some embodiments.

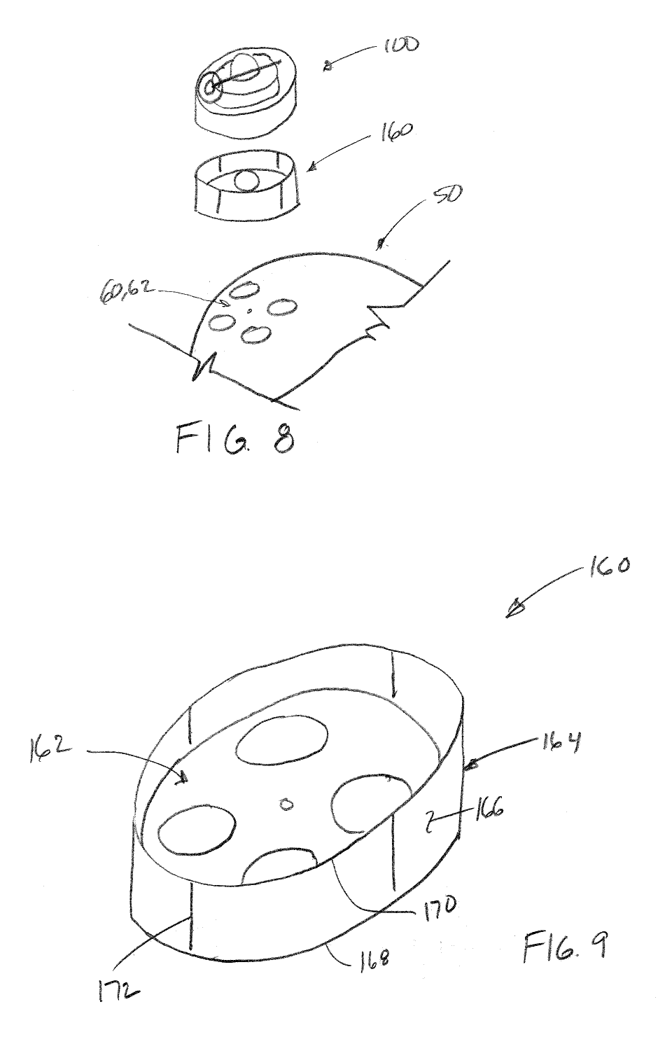

FIG. 8 shows a perspective view of the regulator of FIG. 1 together with a replacement vent and grill.

FIG. 9 shows a close-up view of the replacement vent of FIG. 8.

### DETAILED DESCRIPTION

The present disclosure, in some embodiments, relates to a temperature-based flow regulator for use with solid fuel grills such as charcoal grills and the like. The regulator may include a temperature sensitive coil arranged to controllably open and close a damper. The regulator may be placed over the exhaust vent of a charcoal grill, for example, and may automatically control the exhaust air flow thereby controlling the temperature in the grill. While a charcoal grill is used herein to describe the regulator other types of cooking devices may also be used with the regulator. For example, wood burning stoves, smokers, and other types of cooking or non-cooking devices may have their temperatures regulated with the regulator disclosed herein.

Referring now to FIG. 1, a perspective view of one embodiment of a solid fuel grill 50 having a temperature-based flow regulator 100 is shown. Aside from the flow regulator 100, the solid fuel grill 50 may include a combustion chamber 52 with a removable or otherwise openable lid 54, for example. The grill 50 may include a combustion fuel support grate 56 and the grill 50 may include a food support grate 58 arranged above the fuel support grate 56. The combustion chamber 52 may be equipped with a pair of vents 60, 62 for controlling the air flow through the grill 50 and the grill 50 may include a support system 64, for example, in the form of a series of legs and wheels.

In one embodiment, the vents 60, 62 may include an intake vent 60 located at or near the bottom of the combustion chamber 52 and an exhaust vent 62 located at or near the top of the combustion chamber 52. Each of the vents 60, 62 may be separately and variably openable/closeable for adjusting the open area of the vent 60, 62 to control the air flow through the chamber 52. In one embodiment, the vents 60, 62 may each include a plurality of openings in the wall of the combustion chamber 52 and the openings may be arranged in spaced apart relationship and substantially in a circle. A vent control 66 may be pinned or otherwise secured over the openings such that it can rotate. The vent control 66 may be a plate or other element having an inner surface placed against a wall of the combustion chamber 52 and having an inner surface contour substantially matching that of the outer surface of the wall of the combustion chamber 52 so as to create a relatively tight seal against the chamber 52. The vent control 66 may have a plurality of openings substantially matching the shape, arrangement, and spacing of the openings in the chamber wall. As such, the vent control 66 may be rotated to selectively align the openings in the control 66 with the openings in the chamber 52 to maximize the open area of the vent 60, 62. The vent control 66 may also be rotated to close or partially close the vent 60, 62 by covering all or some, respectively, of the openings in the chamber 52. Still other vent types and control arrangements may be provided including other opening arrangements and shapes as well as sliding, pivoting, or otherwise operable vent controls 66.

The temperature-based flow regulator 100 may be arranged over one of the vents 60, 62 of the grill 50. As shown in FIG. 2, the regulator 100 may include a housing 102 and a damper assembly 104. The housing 102 may be configured for securing to the exterior walls of the combustion chamber 52 of the grill 50 and for holding a damper assembly 104 generally outside the intake or exhaust area of the respective intake or exhaust vent 60, 62. The damper assembly 104 may be configured for operably opening and closing, or partially closing, in response to temperature changes in the combustion chamber 52.

Beginning with the housing 102 and referring to FIG. 3, the housing 102 may include a chamber interface 106 and a damper interface 108. The chamber interface 106 may include a surrounding wall 110 with an interfacing edge 112 and a transition 114. The surrounding wall 110 may be adapted to surround the vent 60, 62 on the combustion chamber 52. The surrounding wall 110 may be cylindrical when viewed from above or a square, rectangular, triangular, or other shaped surrounding wall 110 may be provided. Any suitable shape and size of the surrounding wall 110 may be selected based on the shape and size of the respective vent 60, 62 to be covered such that exhaust gases, for example, may be received from the vent 60, 62 and contained within the housing 102 of the regulator 100. The surrounding wall 110 of the chamber interface 102 may have height extending away from the chamber 52 that is selected so as to clear or extend above any tabs, prongs, or other features associated with the vent 60, 62 and/or vent control 66 on the grill 50. In some embodiments, for example, the surrounding wall 110 may have a height ranging from approximately ½″ to approximately 2″, or from approximately ¾″ to approximately 1½″ or approximately 1″. Other heights, including heights outside the ranges described, may also be used.

The interfacing edge 112 of the chamber interface 106 of the housing 102 may be configured for interfacing with the wall of the chamber 52 and sealing the housing 102 against the chamber 52. As such, the interfacing edge 112 may help to control leakage and/or entry of gases. As such, the interfacing edge 112 may help to assure that the damper assembly 104 is exposed to gases with temperatures reflective of the combustion chamber temperature. In this regard, it is noted that where the combustion chamber 52 is relatively spherical or doubly curved in shape, a cylindrical surrounding wall 110 may provide an interfacing edge 112 with a relatively high sealing ability. That is, in contrast to other shapes with relatively straight edges, a cylindrical surrounding wall 110 may nest against the spherical chamber 52 substantially without gaps. In some embodiments, a rubber, silicone, or other heat resisting sealing ring 116 may be stretched around the surrounding wall 110 and positioned against the chamber 52 along the outside of the surrounding wall 110 to aid in maintaining a seal between the housing 102 and the combustion chamber 52. In other embodiments, a gasket or other seal may be arranged between the housing 102 and the chamber 52. The housing 102 may be secured to the combustion chamber 52 bringing the interfacing edge 112 into substantially continuous contact with the combustion chamber 52 by using adhesives, magnets, clips, welds, or another securing mechanism or device may be provided.

The transition portion 114 of the chamber interface 106 may be adapted to transition from the shape and size of the chamber interface 106 to the shape and size of the damper interface 108. In the present embodiment, the transition 114 may be substantially annular in shape so as to transition from a relatively larger cylindrical surrounding wall 110 of the chamber interface 106 to a relatively smaller cylindrical standoff portion 118 of the damper interface 108. Other suitable shapes and sizes of the transition 114 may be provided and selected based on the relative sizes and shapes of the chamber and damper interfaces 106, 108.

Turning now to the damper interface 108 and with continued reference to FIG. 3, the damper interface 108 may include a standoff portion 118 and a return flange portion 120. The standoff portion 118 may extend upward and away from the transition 114. The standoff portion 118 may have a cylindrical shape when viewed from above, as shown, or other shapes may be provided. The standoff portion 118 may have a height selected in conjunction with the surrounding wall height so as to allow the damper 126 to clear the vent 60, 62 and vent control 66 when operated. It is noted that while the presently disclosed regulator 100 may obviate the need for a vent control 66 on the grill 50, the regulator 100 may be used with or without the presence of a vent control 66. In some embodiments, the vent control 66 may be fully opened prior to installing or placing the regulator 100. In other embodiments, the vent control 66 may be partially opened or it may be removed. In still other embodiments, a replacement vent may be used as shown in FIGS. 8 and 9 described below.

The return flange portion 120 may extend inwardly from the standoff portion 118 and may include an inner edge 122 defining a damper opening 124. In some embodiments, the inner edge 122 may be a circular edge defining a round opening 124 for a round damper 126. In other embodiments, the inner edge 122 may define a square, rectangular, or otherwise shaped opening 124. The diameter of the round opening 124 may range from approximately ½″ to approximately 3″, or from approximately ¾″ to approximately 1½″, or an approximately 1″ opening may be provided. Other opening sizes may be provided and selected based on the size of the grill 50 and the amount of the desired gas flow.

The several parts of the housing 102 may be integral to one another such as where the housing 102 is a single molded piece or a stamped piece, for example. In other embodiments, the several parts of the housing 102 may be separate parts that are adhered, glued, welded or otherwise secured to one another. In still other embodiments, some of the parts may be integral with each other while other parts are not. Still other assemblies of the parts of the housing 102 may be provided. In still other embodiments, the transition portion 114 may be omitted and the surrounding portion 110 and standoff portion 118 may be formed from a single surrounding wall, for example. Still other variations of the housing 102 may be provided.

As shown in FIG. 2, the damper assembly 104 may be arranged atop the housing 102 and adapted to selectively and variably open and close the opening 124 in the housing 102 based on temperature changes. As shown in FIG. 4, the damper assembly 104 may include a damper 126, a temperature sensitive damper controller 128, and an adjustment assembly 130. The adjustment assembly 130 may allow the desired temperature to be selected and the temperature sensitive damper controller 128 may be adapted to automatically adjust the position of the damper 126 to maintain the selected temperature. The damper 126 may be adapted to close the opening 124 in the housing 102 to thereby prevent escape of exhaust gases such that the temperature of the combustion chamber 52 may be maintained or prevented from exceeding a selected temperature.

It is noted that while the particular embodiment shown includes a housing 102 with a damper assembly 104 arranged thereon, some embodiments may include a damper assembly 104 arranged directly on the combustion chamber 52 and the housing 102 may be omitted. For example, where the combustion chamber 52 is designed with features for receiving a damper assembly 104, a housing 102 might not be provided. In either case, the damper assembly 104 may be arranged to be in fluid communication with one of the inlet 60 and exhaust vent 62.

As shown in FIG. 4, the adjustment assembly 130 may include a pivotable shaft 132 arranged on the housing 102. The pivotable shaft 132 may extend across the opening 124 of the housing 102 and be adapted to position a supported damper 126 over and/or within the opening 124. As shown in FIG. 3, the pivotable shaft 132 may be secured to the housing 102 with one or more hoops, hooks, openings in the housing wall, or other securing mechanism or device 134. The pivotable shaft 132 may fit relatively loosely in the securing mechanism 134 such that the pivotable shaft 132 may generally freely rotate about its own longitudinal axis 136 and generally freely translate along its own longitudinal axis 136.

The pivotable shaft 132 may include a dial 138 for setting a desired temperature. The dial 138 may be secured to an end of the shaft 132 such that rotation of the dial 138 causes rotation of the shaft 132. The dial 138 may be arranged on one end of the pivotable shaft 132, for example, and an opposite end of the shaft 132 may include a cap 140. Each of the dial 138 and the cap 140 may prevent the shaft 132 from excessively translating longitudinally. That is, as the shaft 132 translates longitudinally, one of the dial 138 and cap 140 may encounter a portion of the housing 102 such as the standoff portion 118, for example, preventing the shaft 132 from sliding excessively through and/or out of the securing mechanism 134.

A pivot resisting device 142 may also be provided to prevent or limit the free rotation of the pivotable shaft 132. In some embodiments, the pivotable shaft 132 may be arranged in the securing mechanism 134 on the housing 102 with a friction fit. In other embodiments, a toothed rack and pawl may be used to resist free rotation of the pivotable shaft 132. In still other embodiments as shown, a biasing mechanism such as a spring, for example, may be positioned on the shaft 132 between the dial 138 and the housing 102 to engage the housing 102 and bias the pivotable shaft 132. This biasing mechanism may draw the cap 140 or the dial 138, for example, against the housing 102 to create a frictional engagement to prevent free rotation of the pivotable shaft 132. In other embodiments, the biasing mechanism may draw a portion of the damper 126 against the side of the opening 124 creating a frictional engagement to prevent free rotation of the pivotable shaft 132. Avoiding free rotation of the pivotable shaft 132 may allow the user to have confidence that the rotation of the pivotable shaft 132 will remain at a selected radial position such that a selected temperature will be maintained.

As shown in FIG. 5, the damper 126 may be a substantially plate-like element adapted to selectively and automatically close off the opening 124 in the housing 102. The damper 126 may be arranged on the pivotable shaft 132 and adapted to substantially freely rotate about the longitudinal axis 136 of the pivotable shaft 132. The damper 126 may be sized and shaped in coordination with the opening 124 in the housing 102. For example, as shown, the damper 126 may be round and may have a diameter that is substantially equal to or slightly smaller than the diameter of the opening 124 in the housing 102. The damper 126 may include loops, hooks, openings, or other mechanisms or devices 144 arranged on its surface for securing the damper 126 to the shaft 132 with the shaft 132 extending generally across the surface of the damper 126 and generally in plane with the damper 126 and such that the damper 126 may rotate about the shaft 132. Accordingly, when the damper 126 is arranged on the pivotable shaft 132 and the pivotable shaft 132 is secured to the housing 102, the damper 126 may be positioned over and/or in the opening 124 of the housing 102. Rotating the damper 126 about the shaft 132 may allow the opening 124 to transition from fully closed (when the damper 126 is substantially in plane with the return flange 120 of the housing) to fully open (when the damper 126 is rotated to a position substantially perpendicular to the return flange 120 of the housing).

The damper may also include an opening or slot 146 for receiving the temperature sensitive damper controller 128. In some embodiments, the opening or slot 146 may be generally centered on the damper 126 and it may be substantially rectangular in shape. The opening or slot 146 may be arranged to extend generally perpendicularly to the direction of the pivotable shaft 132. The opening or slot 146 may have a length substantially equal to or slightly larger than the diameter of the damper controller 128 and a width substantially equal to or slightly larger than the width of the damper controller 128.

Referring again to FIG. 4, the temperature sensitive damper controller 128 may be arranged to operably couple the damper 126 to the pivotable shaft 132. In some embodiments, the damper controller 128 may be adapted to cause the damper 126 to rotate about the longitudinal axis of the pivotable shaft 132 based on temperature changes. In one embodiment, the temperature sensitive damper controller 128 may be a temperature sensitive coil, such as a bimetal clutch coil. For example, a coil having a deflection of approximately 1.657 angular degrees per degree Centigrade, may be provided. Still other coils having other deflections amounts per degree centigrade may also be provided. The coil may be arranged perpendicularly to the pivotable shaft 132 and the damper 126 as shown and it may be positioned to penetrate the damper 126 as shown. That is, it may be positioned in the slot 146. The coil may be arranged such that the shaft 132 extends substantially through the center of the coil and the coil may be secured to the pivotable shaft 132 in a manner that substantially prevents relative rotation of the inner most portion 148 of the coil relative to the shaft 132. This connection may be provide by adhering, welding, or otherwise securing the coil to the shaft 132. In some embodiments, the shaft 132 may have a flattened portion or the shaft 132 may have a square cross-section for a portion near its mid-length. The inner most portion 148 of the coil may be formed to relatively tightly wrap around the square cross-section thereby preventing rotation of the inner most portion 148 of the coil about the pivotable shaft 132. The opposite end 150 of the coil, or an outermost portion 150 of the coil, may be secured to the surface of the damper 126 beyond the edge of the slot 146 in the damper 126, for example. Accordingly, as the temperature of the coil increases, the outer most portion 150 of the temperature sensitive coil may rotate relative to the inner most portion 148 thereby causing the damper 126 (connected to outermost portion 150 of the coil) to rotate relative to the pivotable shaft 132 (connected to the innermost portion 148 of the coil).

For purposes of calibrating the temperature control of the regulator 100, in some embodiments, the regulator may be placed in boiling water, which boils at 212 degrees Fahrenheit and is conveniently similar to some desired grilling temperatures. When the device is placed in boiling water, the coil may rotate the damper until the coil reaches 212 degrees. At that temperature, a user may remove the regulator 100 from the water and quickly rotate the dial 138 and damper 126 to a fully closed position. As the regulator cools, the damper 126 may open as the coil cools to an ambient temperature. When the regulator 100 is later placed on a grill, for example, the closed position of the damper 126 may thus be reached when grill reaches 212 degrees. Where temperatures above 212 degrees are desired, the user may rotate the dial 138 to cause the damper 126 to travel further to reach the closed position, thereby increasing the temperature at the closed position. Where temperatures below 212 degrees are desired, the user may rotate the dial 138 to cause the damper to travel a lesser rotation distance to reach the closed position, thereby decreasing the temperature at the closed position.

In other embodiments, for example at the time of manufacture, the regulator 100 may be calibrated in the same way or in other ways. In some embodiments, the relationship between temperature degrees and angular gradations on the dial 138 may match that of the coil. For example, the dial 138 may also include temperature indicating lines radiating from its center that reflect the 1.657 angular degrees per degree centigrade. In this embodiment, rotation of the dial 138 may, thus, cause rotation of the damper 126 the same amount thereby reflecting similar temperature differentials. In some further embodiments, as shown in FIG. 6 for example, when the dial 138 is secured to the shaft 132, the ambient temperature at the time and location of the dial installation (e.g., 70 degrees Fahrenheit) may be aligned with the plane of the damper 126. As such, when the ambient temperature increases or decreases, the damper 126 may travel relative to the dial 138 such that a view of the front of the dial 138 may allow for a temperature reading by siting the position of the damper 126 beyond the dial 138. As shown, when the device is in use, the damper position may reflect the temperature of the surrounding environment. Before the grill 50 warms up, the damper may reflect, for example, 80 degrees F. on a warm summer day. In this position, the damper 126 may have rotated a preliminary angle 152 of 10 degrees from the manufacturing temperature. In this embodiment, setting the temperature on the dial 138 may be performed by aligning the desired selected temperature on the dial 138 with the plane of the return flange 120. As such, and as shown in FIG. 6, if the desired temperature is 225 degrees, such a temperature indication on the dial 138 may be aligned with the return flange 120 causing the position of the damper 126 to be as shown and aligned with the ambient temperature before the grill 50 warms up. As the grill temperature increases, the damper 126 may rotate through a differential angle 154 relative to the dial toward the 225 degree temperature and may reach that temperature on the dial 138 at the same time that the damper 126 fully closes the opening 124 in the housing 102. Still other relationships and temperature setting positions can be used and may be selected by the manufacturer to suitably control the temperature of the grill 50.

In some embodiments, a stop may be provided to prevent over rotation of the damper 126. For example, a tab may extend inwardly from the return flange 120, for example, to engage the damper 126 as it approaches a fully closed position. As such, if the temperature exceeds a desired selected temperature, the damper 126 may avoid continuing to allow air into the combustion chamber due to over rotating, for example. In other embodiments, a perimeter lip or rim may be provided on the damper 126 to allow the damper to nestably seal against the rim of the opening 124. For example, the downward extending portion of the damper 126 may have a rim or lip for engaging the inside surface of the return flange 120 and the upward extending portion of the damper 126 may have a rim or lip for engaging the outside surface of the return flange 120.

In some embodiments, a thermometer 156 may be provided on the housing 102 or the grill 50 for monitoring the temperature of the combustion chamber 52.

In still other embodiments, as shown in FIG. 7, a novelty feature 158 may be provided that encloses, decorates, or otherwise accentuates the presence of the regulator 100 on the grill 50. In some embodiments, the novelty feature 158 may include a football helmet of a favorite football team, a home team associated with a tailgating event, or other football team. In other embodiments, the novelty feature 158 may include a bust or head of a television, movie, or broadcasting personality, or a celebrity, for example, such as Larry the Cable Guy or other public figure or character. In still other embodiments, skulls, moose heads, or other decorative novelty features 158 may be provided and the novelty feature 158 may be associated with activities for which grilling is being performed.

In some embodiments, as shown in FIG. 8, the regulator 100 may be used with a replacement vent 160. That is, for example, a vent controller 66 may be replaced with the replacement vent 160. The replacement vent 160 may be configured for attaching to the grill 50 in a location the same or similar to the vent control 66 and over one of vents 60, 62. The replacement vent 160 maybe further configured for receiving the regulator 100. In some embodiments, the use of the replacement vent 160 may alleviate the need for the seal 116. In other embodiments, the replacement vent 160 and seal 116 may be used together.

As shown in the close-up view of FIG. 9, the replacement vent 160 may include a grill interface 162, and a regulator interface 164. The grill interface 162 may be adapted for placement against an outer surface of a grill 50 and for providing fluid communication between the grill 50 and the regulator 100. The grill interface 162 may be a generally flat and thin element and may further include a contoured surface for generally continuous contact with the outer surface of the grill. The generally flat and thin element may include a circular or other shaped perimeter having a size and shape generally matching that of the regulator 100. The grill interface 162 may be attachable to a grill 50 with a center pin in the form of a bolt, rivet, screw, or other fastener. The grill interface may include one or more openings corresponding to openings in the grill to allow air or other fluids or gases to flow from the vents 60, 62 through the grill interface 162 of the replacement vent 160.

The regulator interface 164 may extend upwardly from the grill interface 162 and may be adapted for engagement with the regulator 100. In some embodiments, as shown, the regulator interface 164 may be a relatively thin walled element 166 having an inner edge 168 that follows the perimeter of the grill interface 162. The thin walled element 166 may extend away from the inner edge 168 a distance similar to the surrounding wall height of the regulator 100 to an outer edge 170. In some embodiments, the regulator interface 164 may include slots 172 extending from the inner edge 168 and through the outer edge 170. Accordingly, the surrounding wall 110 of the housing 102 of the regulator may be received by the slots 172 and may alternately enter and exit the interior cavity of the replacement vent 160 by alternately penetrating into and out of the slots 172. The friction resulting from the position of the surrounding wall 110 through the thin walled element 166, may secure the regulator 100 to the replacement vent 160 and, thus, to the grill 50. Other attachment mechanisms may also be provided.

In operation, a user may position the regulator 100 over a vent 60, 62 of a grill 50 and secure the regulator 100 to the grill 50. In some embodiments, prior to placing the regulator 100, the user may remove the vent controller 66 on the grill 50 or place it in an open or partially open position. In some embodiments, the regulator 100 may be sealed to the combustion chamber by positioning a seal 116 at or near the interface of the housing 102 and the combustion chamber 52. The user may then prepare the grill 50 by adding fuel, adjusting the height of food grates 58 and the like. Other food preparation or other steps may also be performed.

When the user is ready to rely on the regulator 100 for temperature control, the user may adjust the dial 138 together with the pivotable shaft 132 to a desired temperature. In some embodiments, the temperature may be selected and the dial 138 rotated when the grill 50 is still cool, for example. The rotation of the pivotable shaft 132 with the dial 138 may rotate the damper 126 between a closed position (e.g., substantially covering the opening 124 in the housing 102), a partially closed/open position, and a fully open position (e.g., position substantially 90 degrees to the plane of the return flange 120). It is noted that the temperature sensitive controller 128 may function under temperature increases to rotate the damper 126 in a first direction. As such, while fully open is described as 90 degrees from fully closed, this position may not provide the hottest combustion chamber temperature. That is, by rotating the damper 126 with the dial 138 in a direction opposite that of the first direction and beyond the 90 degree position, the temperature required to fully close the damper 126 may be higher than if the damper 126 was initially positioned in the 90 degree position.

As the temperature of the combustion chamber 52 and, thus, the temperature of the exhaust gases passing through the regulator 100 increase, the temperature sensitive damper controller 128 (e.g., coil) may cause the damper 126 to rotate gradually toward a closed position. As the damper 126 closes, the amount of air, and thus oxygen, available for combustion may be reduced thereby reducing the temperature in the combustion chamber 52 and regulating the temperature for cooking, for example. In some embodiments, the damper 100 may approach or reach a fully closed position at or just above the desired selected temperature. Having closed and thereby cut off oxygen supply, the combustion chamber temperature may begin to fall. As the combustion chamber temperature cools slightly below the desired selected temperature, the damper 126 may reopen to allow more air into the combustion chamber 52 and thereby allowing the combustion chamber 52 to heat up again to the desired selected temperature where the damper 126 may again close. The process may continue to maintain the temperature of the grill 50 at the desired selected temperature. In this embodiment, the temperature in the combustion chamber 52 may ebb and flow or oscillate about the desired selected temperature as the damper 126 oscillates between partially open and fully closed.

It is to be appreciate that the flow regulator 100 may be used with charcoal, wood, pellet or other grill fuels. The regulator 100 may be advantageous to allow for air flow regulation based on temperature. It is also to be appreciated that while the regulator 100 has been described as being arranged on the combustion chamber 52, some smokers and other grilling systems have isolated compartments for fuel and food. In these embodiments, the described combustion chamber 52 may be considered to be the entire unit including the fuel compartment and the food compartment where the air inlet 60 is arranged on the fuel compartment and the exhaust 62 is arranged on the food compartment.

It is also noted that while the regulator 100 has been described as a separate part that is secured or otherwise coupled to a grill 50, the regulator 100 may be incorporated into a grill 50 and made part of the grill 50. That is, the housing portion 102 of the regulator 50, for example, may be integral with the wall of the combustion chamber 52 and the damper assembly 104 may be arranged thereon. Accordingly, a grill 50 having a more permanent regulator 100 is within the scope of the present invention.

It is also to be appreciated that different housing shapes and sizes may be provided and different damper assembly configurations may also be provided. For example, a damper assembly having a damper that rotates about an edge of the damper may be provided rather than the above-described damper that generally rotates about a line extending across its surface and through its center. In still other embodiments, a sliding damper that articulates back and forth across an opening, for example, may be provided. Still other shapes and sizes of dampers with other actuating means may also be provided.

Although the invention has been described with reference to various embodiments, persons skilled in the art will recognize that changes may be made in form and detail without departing from the spirit and scope of the invention.

What is claimed is:

1. A flow regulator for controlling the temperature of a solid fuel grill, comprising:
a housing having an opening and configured for coupling to the solid fuel grill over a vent opening of the grill; and
a damper assembly arranged on the housing, the damper assembly comprising:
a damper arranged to operably and variably open and close the opening; and
a temperature sensitive damper controller operably connected to the housing and the damper to open and close the damper based on temperature changes.

2. The flow regulator of claim 1, wherein the temperature sensitive damper controller includes a temperature sensitive coil.

3. The flow regulator of claim 2, further comprising a pivotable shaft wherein the coil is operatively connected to the housing via the pivotable shaft.

4. The flow regulator of claim 3, wherein the pivotable shaft includes dial for user selection of a desired temperature.

5. The flow regulator of claim 3, wherein the pivotable shaft is arranged on the housing and the damper is secured to the shaft with a first connection adapted for substantially free rotation of the damper about an axis of the shaft.

6. The flow regulator of claim , wherein the first connection includes a loop.

7. The flow regulator of claim 3, wherein the damper is connected to the shaft with a second connection adapted to control the relative angular position of the damper and the shaft.

8. The flow regulator of claim 7, wherein the second connection is the coil.

9. The flow regulator of claim 1, further comprising a replacement vent adapted for securing to the grill and further adapted to receive the housing.

10. The flow regulator of claim 1, further comprising a novelty feature arranged to enclose the housing and the damper assembly.

11. A flow regulated solid fuel grill, comprising:
a combustion chamber for burning solid fuels and having an inlet vent and an exhaust vent; and
a flow regulator for controlling the temperature of the grill, the regulator arranged in fluid communication with one of the inlet vent and the exhaust vent and comprising:
a damper assembly comprising:
a damper arranged to operably and variably open and close; and
a temperature sensitive damper controller operably connected to the damper to open and close the damper based on temperature changes in gases passing through the respective vent.

12. The grill of claim 11, wherein the temperature sensitive damper controller includes a temperature sensitive coil.

13. The grill of claim 12, further comprising a pivotable shaft wherein the coil is operatively connected to the grill via the pivotable shaft.

14. The grill of claim 13, wherein the pivotable shaft includes dial for user selection of a desired temperature.

15. The grill of claim 13, wherein the pivotable shaft is arranged on the grill and the damper is secured to the shaft with a first connection adapted for substantially free rotation of the damper about an axis of the shaft.

16. The grill of claim 15, wherein the first connection includes a loop.

17. The grill of claim 13, wherein the damper is connected to the shaft with a second connection adapted to control the relative angular position of the damper and the shaft.

18. The grill of claim 17, wherein the second connection is the coil.

19. The grill of claim 11, further comprising a replacement vent arranged between the flow regulator and the respective vent.

20. A flow regulator for controlling the temperature of a solid fuel grill, comprising:
a means for sensing the temperature of the grill and reacting to the temperature to control flow of air through the grill; and
a means for securing the means for sensing and reacting to the grill over a vent of the grill.
